(19) United States
(12) Patent Application Publication
(10) Pub. No.: US 2014/0052676 A1
(43) Pub. Date: Feb. 20, 2014

(54) Portable performance support device and method for use

(71) Applicants: Ronald E. Wagner, Fleming Island, FL (US); Robert Charlton, Fredericksburg, VA (US); Greg Thompson, San Diego, CA (US); Robert Ufford, Roswell, GA (US)

(72) Inventors: Ronald E. Wagner, Fleming Island, FL (US); Robert Charlton, Fredericksburg, VA (US); Greg Thompson, San Diego, CA (US); Robert Ufford, Roswell, GA (US)

(21) Appl. No.: 12/800,913

(22) Filed: May 25, 2010

Related U.S. Application Data
(63) Continuation of application No. 12/660,205, filed on Feb. 23, 2010, now abandoned.
(60) Provisional application No. 61/154,603, filed on Feb. 23, 2009.

(51) Int. Cl. G06F 15/18; G08B 21/00

(52) U.S. Cl. 706/13; 340/540

(57) ABSTRACT

A user is provided with a portable performance support device that allows the user to be connected with all relevant information required for a task; determines the relevance and priority of a task; assesses an event or condition and provides knowledge to the user by collecting information from actions taken, learning from said actions and making knowledge gained therefrom available to the user.

### RELATED APPLICATIONS

This is a continuation of co-pending patent application Ser. No. 12/660,205 filed Feb. 23, 2010 entitled Portable Performance Support Device and Method for Use and claims rights under 35 USC §119(e) from U.S. Application Ser. No. 61/154,603 filed Feb. 23, 2009, the contents of which are incorporated herein by reference.

### FIELD OF THE INVENTION

The present invention relates to portable performance support devices and more particularly to devices which are handheld, mobile, and which have active windows into the data, information, and knowledge required for decision making action and task execution at the point of performance.

### BACKGROUND OF THE INVENTION

Vehicle operators, maintainers, original equipment manufacturers, fleet support personnel or fleet business managers are all susceptible to making critical decisions about vehicle/fleet operation, maintenance, support or cost decisions based on outdated, prior information from disparate data sources. The point of performance at which decisions may have to be made are often on vehicles, in the shadow of the vehicle, or remote from a company network where information sources could be obtained. Thus solutions are required to be mobile, cost effective and be readily available to the decision maker. At various points of performance where decision points require action, the individual has information overload and is not able to quickly access and evaluate the current event, condition, or situation that requires action. In addition, it is important to prioritize, rank, and sequence the next steps to be taken. Further, where there are gaps in information, the person at the site often is required to make an extraordinary effort in order to find all the information required to complete the next step or make the decision. This expends valuable time and resources unnecessarily. Traditional tools and applications offer single point solutions based on perfect data, but cannot take advantage of all information sources which could help fuse data into knowledge or integrate disparate data into cohesive information.

A need, therefore, exists for an improved way to take advantage of diverse information sources in managing vehicle support maintenance.

More particularly, a vehicle fleet management system such as described in U.S. patent application Ser. No. ______, docket number BAEP-1159 entitled Telenostics, assigned to the assignee hereof, filed on even date herewith, and incorporated herein by reference, shows a method known as telenostics which addresses remote and mobile assets as well as fleet operations. This method enhances mission performance at minimum total ownership cost by providing both diagnostics and prognostics such as described in U.S. patent application Ser. No. 12/548,683, entitled Prognostic, Diagnostic, Capability Tracking System (PRDICTR), filed Aug. 27, 2009 assigned to the assignee hereof and incorporated herein by reference.

In this patent application faults are diagnosed and isolated as well as predicted. Fleet managers utilize the adaptive diagnostics and prognostics to analyze a system in terms of failure modes and then use modeling and simulation to troubleshoot back to the node for which a fault is detected or expected. This information comes from real time data acquisition and realtime updating of field manuals so as to provide a mechanic with the latest update information.

The realtime data input to the system, as described in U.S. patent application Ser. No. ______, entitled Diagnostic Connector Assembly (DCA) Interface Unit (DIU) and filed on even date herewith, docket number BAEP-1140, realtime data from a vehicle is in one embodiment supplied by a DIU, a diagnostic interface unit, that is plugged into the vehicle to provide the data required to sense vehicle operation as well as driver performance.

Regardless of the interface unit, there is a need for a portable device for providing maintenance personnel with appropriate updated information so that they can maintain the fleet on the spot. There is also a need in spite of the existence of a DIU, for a single device which includes sensors for being able to sense the environment at the vehicle and to be able to provide an interface to maintenance personnel so that they can take advantage of the processed information and updated maintenance instructions.

In such a portable device, it would be useful for instance to have sensors that detect noxious gases that often exist in mines. Also a sensor might include a man-down indicator or might be provided with the ability to communicate over a number of different communication protocols.

Specifically, fleets of vehicles are oftentimes deployed down below the surface of the earth in the mines where personnel are exposed to gases such as methane. These noxious gases must be continually monitored and their existence must be communicated to above ground personnel, for instance if concentrations of methane gas exceed a predetermined threshold. Moreover, it would be convenient if a handheld device provided proximity checking or alerting when for instance a person is separated more than a predetermined distance from the vehicle to which he is assigned.

Additionally, it would be convenient if a driver tasked to perform safety checks and to inspect multiple points on a vehicle could be provided with for instance an RFID reader so that the individual could walk around a vehicle and be detected at certain pre-placed labels. This would provide a record that an operator performed their daily inspection as well as any necessary pre-trip inspections.

Moreover, when for instance vehicles contain perishable items, biological sensoring would be useful in detecting about to occur spoilage of perishable freight and sensors utilized by maintenance personnel could be provided to alert of the presence of E coli or salmonella.

While in the past, handheld PDAs such as iPhones exist, they do not incorporate sensoring capability and are not in general capable of displaying a large amount of information, especially in a way that maintenance instructions and manuals might be deliverable, especially from a telenostics center.

In short, it is important that information be brought to the point of performance as well as providing data from the point of performance back to a centralized site.

Note, Telenostic systems are described in the following U.S. patent applications, filed on even date herewith, assigned to the assignee hereof and incorporated herein by reference: Ser. No. ______ (docket number BAEP 1140) Diagnostic Connector Assembly (DCA) Interface Unit (DIU), Ser. No. ______ (docket number BAEP 1141) In Service Support Center and Method of Operation, Ser. No. ______ (docket number BAEP 1159) Telenostics, Ser. No. ______ (docket number BAEP 1161) Telenostics Performance Logic, and Ser. No. ______ (docket number BAEP 1162) Telenostics Certify.

### SUMMARY OF INVENTION

In order to provide for convenient maintenance personnel instruction and to permit point of performance a miniaturized portable performance support device in the size of a key fob provides for ready data collection and transmission to a centralized data processing location and provides ready visualization of updated maintenance instructions from the site. In one embodiment of the subject invention a handheld device, no bigger than a key fob, is provided with sufficient communications capabilities to be able to communicate with a centralized office.

In a preferred embodiment, the device is provided with clip-on modules that adapt the device to virtually any of a wide variety of applications in which for instance the clip-on modules may include noxious gas sensors, RFID tag readers, man-down and vehicle proximity sensors as well as optical, biological, chemical, explosive, audio or RF sensing devices.

Additionally, the subject device is provided with clip-on content displaying modules which, for instance, include a miniature projector to project received information onto an adjacent wall or even a persons shirt. The clip-on devices can also include optical viewing devices such that the entire maintenance procedure or other information is viewable, not on a small screen, but rather in the full field of view of the eye.

In one embodiment, modules associated with the key fob device can include for instance a cellular modem, a GPS receiver, serial inputs, discrete inputs, a wide variety of outputs, the ability to provide remote firmware updates, security features such as beacons and electronic keys, the ability to connect to WiFi hot spots, RFID readers, scanners for 2D matrix and barcode readers, user inputs including touch screens and voice microphones, a USB interface, a J1708 interface, a J1939 interface, various universal connectors for communications, and the ability to acquire video and to permit video conferencing.

The present invention thus comprises a portable performance support device (PPSD) that provides the ability to sense, connect, analyze, predict, and perform and thus provides each user at a selected decision point within a process or architecture the ability to transmit and obtain data. These portable performance support devices operate within a point of performance operating architecture on, at, and off a system. They are configured to be mobile in order that they be available and transportable to the decision maker, while maintaining a high degree of connectivity options. The primary discriminator in the subject solution is the algorithm and application that when synthesized provides results at the point of performance based on the available levels of synthesized knowledge from information and data available.

In summary, a portable performance support device includes a key fob size transceiver and processor that is adapted to accept clip-on modules for environmental sensing and for display of large amounts of information. The display modules include a specially-designed eye piece or projector. Also the clip ons can function as communications modules which enable connectivity between the support device and a central server.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of the portable performance support device showing its miniaturized size and a clip-on module;

FIG. 2 is a diagrammatic illustration of the utilization of the portable performance support device to provide maintenance instructions to maintenance personnel, in which the clip-on module projects the maintenance information or procedures on a nearby surface or wall;

FIGS. 3A, 3B and 3C are respectively a front view of the portable performance support device, a back view of the portable performance support device and a front view of the clip-on module of FIG. 1;

FIG. 4 is a diagrammatic illustration of the operation of the portable performance support device of FIG. 1, illustrating the capabilities thereof;

FIG. 5 is a diagrammatic illustration of an in-service maintenance system in which the portable performance support device of FIG. 1 generates sensor and data inputs and receives the results of off site data analysis and performance monitoring; and,

FIG. 6 is a diagrammatic illustration of an in-service support center illustrating various functions attributable to a logistics and maintenance organization in which information relating to vehicles is obtained as realtime data from the subject device and in which maintenance personnel and logistics personnel at a vehicle are provided with on-site information from a in-service support telenostics center.

### DETAILED DESCRIPTION

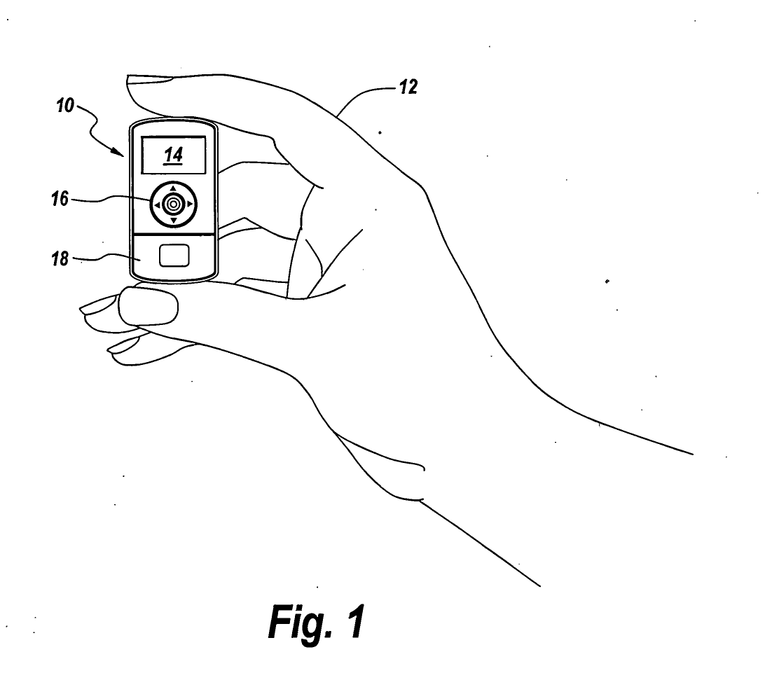

Whether used in a vehicle maintenance program or in fact for any maintenance program in which apparatus or individuals are to be serviced or treated, as can be seen from FIG. 1, a key fob sized portable performance support device 10 is shown hand carriable as illustrated by hand 12 and includes, in one embodiment a display 14, a data and command entry device 16 and a clip-on module 18.

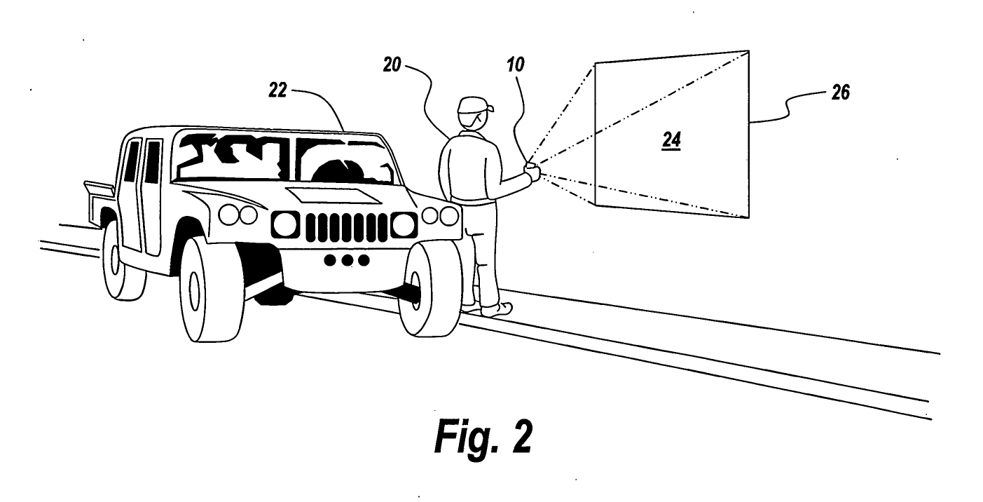

Referring to FIG. 2, in one embodiment the subject portable performance support device is used by a mechanic or support personnel 20 in the vicinity of for instance a vehicle 22 to provide maintenance personnel with projectable maintenance instructions 24, here projected onto a wall 26, a persons shirt or onto any surface. The portable performance support device in one embodiment carries a projector that projects information from a server to aid maintenance personnel or technicians performing the particular support function required.

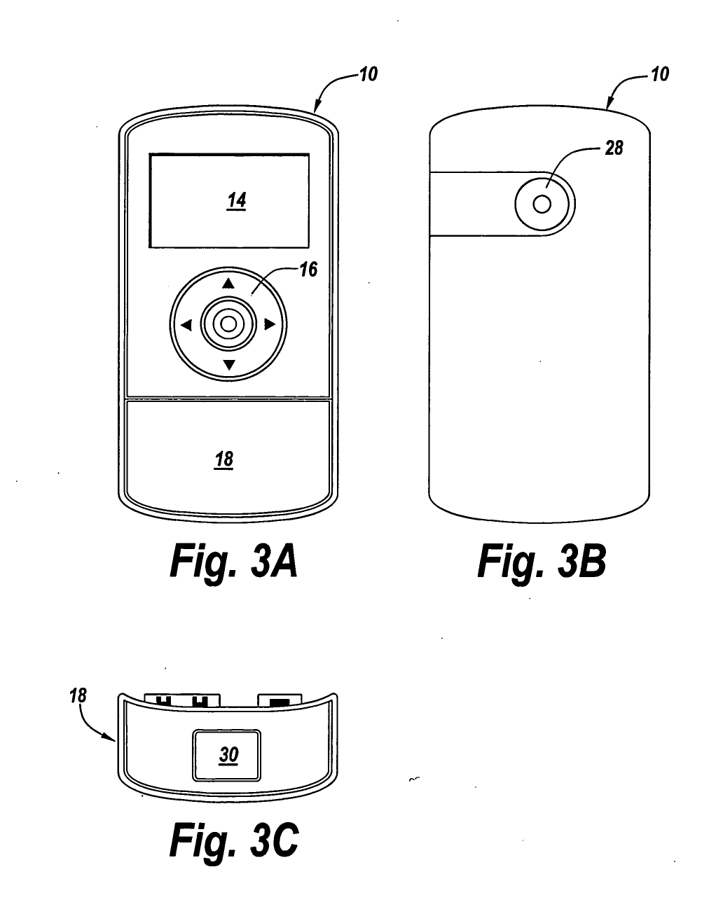

Referring to FIG. 3A, device 10 may include display 14 and input device 16, as well as clip-on module 18 which in the embodiment of FIG. 2 includes a miniaturized projector.

FIG. 3B shows the backside of device 10 which includes a digital camera 28 for capture and transmittal of site images.

Referring to FIG. 3C, module 18, in one embodiment may include a optical viewing port 30 which is attachable as a clip-on module to device 10, with the optical device also including for instance a miniaturized projector so that maintenance instructions can be made available on site through a key fob size device which ordinarily would not have the required display space for presenting adequate maintenance instructions.

It is noted that module 18 also may be configured to be a communications module for various types of communications protocols, or in fact may include sensors such as for instance noxious gas sensors, with the portable performance support device providing a remote server with realtime data relating to the device to be maintained.

It is noted that the clip-on unit can contain for instance communications transceiving apparatus, sensors of all kinds including gas sensors, sensors which can detect the condition of the equipment to be maintained or persons to be treated, and in general is utilized as a means for rapidly configuring the portable performance support device for various functions in which realtime data needs to be extracted from the site and in which instructions need to be transmitted back to service personnel who provide necessary repairs and/or treatment in the case of medical monitoring.

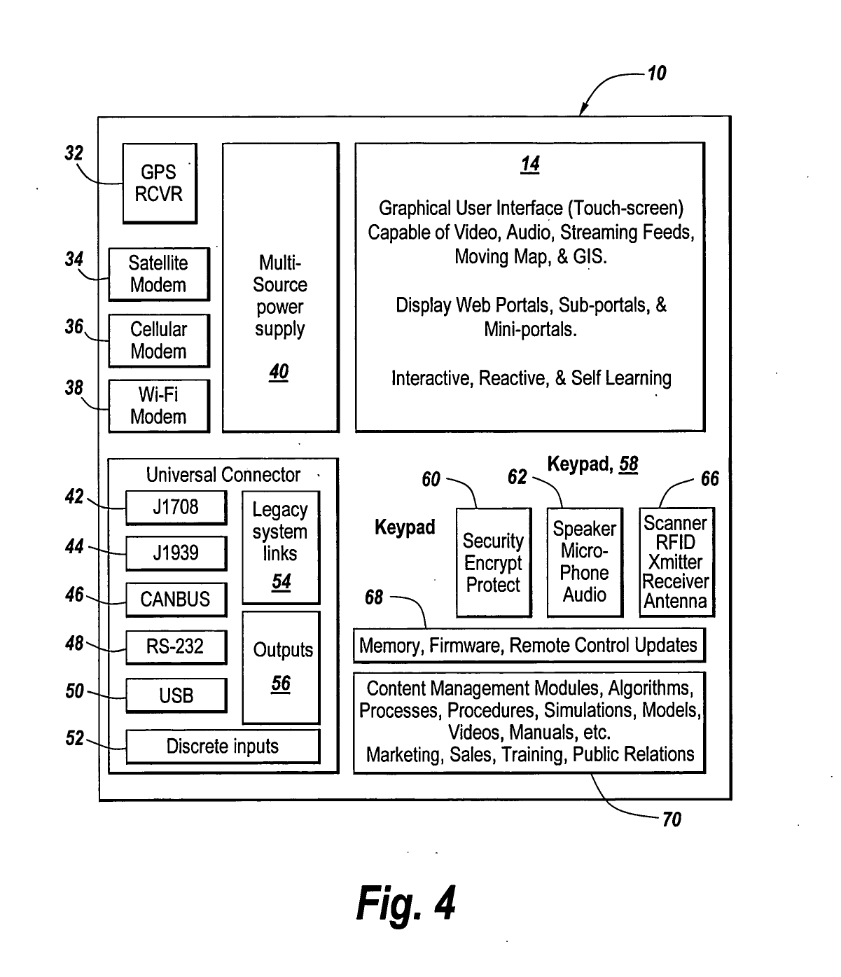

Referring now to FIG. 4 in terms of the operation of the subject portable performance support device 10, it will be appreciated that processors within the clip-on device may provide the device with the functionality to perform sensing and display functions. Moreover the device may include a GPS receiver 32, a satellite modem 34, a cellular modem 36 or a WiFi modem 38. Also associated with the device may be a multi-source power supply 40.

The portable performance support device may also be provided with a universal connector system 40 that may include the following connectors: J1708-42, J1939-44, a CAN bus connector 46, an RS-232 connector 48, a USB connector 50 or connectors relating to discrete inputs here illustrated at 52.

Also included are legacy system links 54 which accommodate outputs from the device here illustrated at 56. Display 14 may include a graphical user interface in the form of a touch screen display, or a display capable of video, audio, streaming feeds, moving map applications and GIS applications. The display may also support display web portals, sub-portals and mini portals and may be interactive, reactive or self learning.

Note that keypad 58 which can correspond to data entry device 16 and can be used to security encrypt or protect as illustrated at 60, can adjust speaker microphone and audio levels as illustrated at 62, or may control activation of scanners, RFID tags and receiver antennas as illustrated at 66.

Finally the device 10 includes memory, firmware and remote control updating facilities as illustrated at 68, whereas as illustrated at 70 device 10 may include content management modules, algorithms, processes, procedures, simulations, models, videos, manuals and other information. While the subject invention will be discussed in terms of fleet management, it will be appreciated that other types of data collection, processing and instruction conveying systems are within the scope of the subject invention. This includes the use of the subject device in hospitals, in doctor's offices, or by EMTs or other medical personnel. Finally marketing, sales, training and public relations information is available at 70.

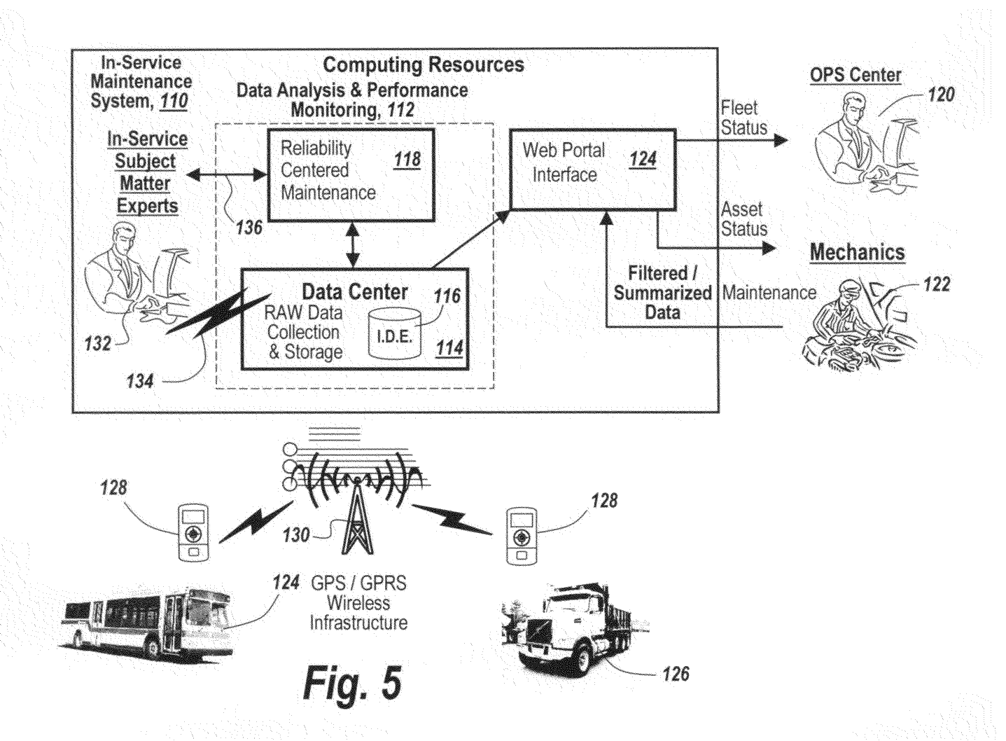

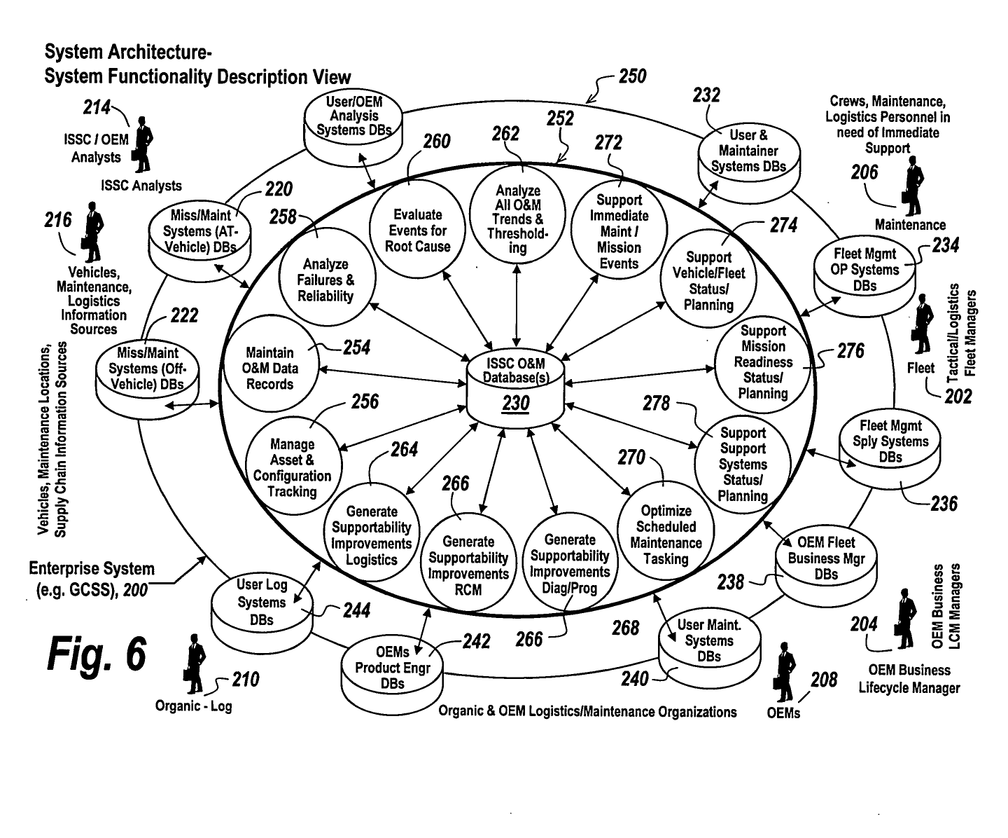

While the subject portable performance support device is useful in a number of applications in which either machinery or patients require a support service, one particularly important application is in an in-service maintenance system which is shown in FIGS. 5 and 6. In terms of the in-service maintenance system, this system as noted above is described more fully in U.S. patent application Ser. No. ______, entitled Telenostics. This system is referred to as a telenostics system and is utilized to analyze realtime data and provide instructions to on site mechanics by transferring the processed information from the telenostics module to the site at which service is required.

Referring to FIG. 5, an in-service maintenance system 100 which can take advantage of the subject device involves computing resources that include a data analysis and performance monitoring module 112.

Included in the computing resources is a data center 114 which collects raw data and stores it in an integrated data environment 116 that incorporates the results of all stored data. Data center 114 then outputs the results of real-time diagnostics and prognostics to enable recommending changes to maintenance plans. These revised or updated plans are communicated to either an operation center 120 or to mechanics 122, in this case through the use of the subject portable performance support device. In one embodiment, this is accomplished through the use of a web portal 124.

It is the purpose of the data analysis and performance monitoring module 112 to perform real-time mission monitoring performance optimization utilizing diagnostics and prognostics, with the diagnostics and prognostics being updated utilizing real-time data from for instance a bus 124 or truck 126, again in part provided by the subject device. Real-time location-based usage monitoring, diagnostics, exceedances and sensor data is transmitted via a communications interface involving a transmitter 128 that uses terrestrially-based towers or satellites 130 to provide a wireless infrastructure from which data collected from the vehicles is transmitted via the subject device to data analysis and performance monitoring module 112.

Thus, not only is real-time location tracked at module 112, also usage of the asset is tracked, as well as real-time diagnostics information having parameters which are transmitted over a wireless link and infrastructure along with sensor data provided by the subject device. Any on-board diagnostics information is also transmitted wirelessly, as well as the fact of an exceedance of a performance standard.

As can be seen, in-service subject matter experts 132 are either wirelessly linked or hard wired to the data and analysis performing module 112 as illustrated respectively at 134 and 136. As a result reliability-centered maintenance can be provided by the in-service subject matter experts. Moreover, the results of the diagnostics and prognostics are transmitted back to the in-service subject matter experts.

It will be appreciated that in one embodiment sensor data is transmitted continuously in part by the subject device to operation maintenance center 120, and to the integrated data environment 116.

Actionable information is automatically provided to the in-service subject matter experts through an in-service terminal. Moreover maintainers, such as mechanics 122, are provided with updated instructions by the subject portable performance support device.

Note that in one embodiment performance monitoring and diagnostics are available on-vehicle, whereas in another embodiment the data analysis and performance module 112 performs the diagnostics and prognostics.

Referring now to FIG. 6, and as discussed in patent application Ser. No. ______, docket number BAEP-1141, entitled In Service Support Center and Method of Operation, assigned to the assignee thereof and incorporated herein by reference, and the subject performance support device may be used in conjunction with an enterprise system 200, which has as stakeholders tactical logistics fleet mangers 202, life cycle management 204, crews, maintenance and logistics support personnel in immediate need of updated support 206. The enterprise system can include original equipment manufacturers 208, organic logistics personnel 210 and analysts 214.

The fleet vehicles for which maintenance and logistics information is available are collectively illustrated at source 216. Vehicles, maintenance locations, supply chain information and other vehicle-related sources are shown at mission/maintenance systems vehicle databases 220 and at mission/maintenance systems off-vehicle databases 222. Also available to the support center database, here illustrated at 230, are user and maintainer system databases 232, fleet management operational system databases 234, fleet management supply systems databases 236, optimization and maintenance fleet business manager databases 238, user maintenance system databases 240, optimization and maintenance product engineering databases 242, and user logistics system databases 244.

All of these databases in the outer ring 250 of the enterprise system are coupled to in-service support center (ISSC) ring 252 which has at its center the in-service support center optimization and maintenance database 230.

It is noted that bi-directional communication is provided between the external databases and the support center database such that information can be inputted into the ISSC database, with analysis retrieved from the database.

From the vehicle perspective, optimization and maintenance records are available at 254, whereas as illustrated at 256 management asset and configuration tracking interfaces are available that uses database 230.

There is a function 258 within the support center that involves analyzing failures and producing statistics with respect to reliability, whereas as illustrated at 260 there is a facility for evaluating events for the root cause of failure and as illustrated at 262 and for analyzing optimization and maintenance trends and thresholding.

As can be seen database 230 is used to generate supportability and improvements, as well as logistics information 264, and supports the generation of supportability improvements with respect to reliability-centered maintenance 266.

Information to and from database 230 is used to generate supportability improvements in terms of diagnostics and prognostications as illustrated at 268, whereas database 230 supports the ability to optimize scheduled maintenance tasking as illustrated at 270.

Database 230 is under control of maintenance management which includes for instance the ability to support immediate maintenance and mission events as illustrated at 272, the ability to support vehicle fleet status and planning initiatives illustrated at 274, the ability to output system status and planning as illustrated at 276 and the ability to support mission readiness status and planning as illustrated at 278.

What will be seen is that support system 200 supports inputs of large amounts of data automatically from vehicles in part from the subject device, manages the data with respect to diagnosis and prognostication for system faults and errors, reports the availability of vehicles and the like as well as their locations, provides all of the managers ready access to fleet information and provides an output to crews and maintenance personnel in need of the immediate support supplied by the subject device. Thus analysis from an embedded system, an at-platform system or through the analysis performed at the subject off-platform support center is available wherever the subject portable performance support device is located.

In summary, what is shown is an in-service support center the purpose of which is to take realtime data from the field and merge it with algorithms and pre-stored data to provide analysis as to the causes of failure in the field, to analyze the root causes of these failures, to analyze trends of the failures, and to provide information to maintenance to maintenance personnel by way of the subject portable performance support device to be able to address the faults or problems detected.

Specifically, the portable performance support device of the present invention is a handheld, self-powered (battery and/or solar), display terminal with a user interface keypad, video, audio, graphical, and tactile sensory features. It also has some of all of the embedded components listed below:

A. Physical requirements
1. cellular modem
2. GPS receiver
3. serial inputs
4. discrete inputs
5. output
6. remote firmware updates
7. security features, i.e. beacon, electronic key
8. connect to WiFi
9. RFID
10. scan 2d/matrix/bar code
11. user inputs
12. touch screen
13. voice microphone
14. USB interface
15. j1708 interface
16. j1939 interface
17. universal connector
18. withstand extreme heat and cold
19. withstand extreme environment found aboard ocean bearing ship
20. satcom
21. display of tech drawings
22. external output to other devices
23. synthetic instruments
24. video links
25. video conference
   B. Content management
1. browser based
2. data enrichment
3. operator feedback
4. legacy system interface, i.e. work order, timecard
5. security features, e.g. encryption
6. technical steps
7. fault code
8. event code
9. condition code
10. provides the specific decision point or instruction
11. tracks performance
12. provides training
13. queue next action
14. interacts with other people
15. systems
16. virtual points of performance
17. internet portals
18. transactional systems
19. algorithms
20. modeling and simulations
21. run EEOs

Those skilled in the art will appreciate that the portable performance support device provides for constant, immediate, and ubiquitous usage. Thereby, the new apparatus provides an individual with the data, information, knowledge, and performance logic within one device, perhaps only one screen to complete a task or series of tasks. Another feature of the portable performance support device is that it is constantly learning, it possesses an artificial intelligence schema that teaches the logic to utilize a series of algorithms to perform even better with each use. Thus, it is always improving the outputs, honing the logic, and ensuring the accuracy of the knowledge. This self-learning technique is one of the important features of the invention and replicates itself at several levels throughout the performance oriented architecture.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

1. A system comprising:
a key fob sized portable performance support device for allowing a user to be connected with all relevant information required for a task, said key fob sized portable performance support device including a clip-on module having a predetermined sensor, a transceiver and a display, thus to provide said key fob sized portable performance support device with selectable functionality based on the particular clip-on module clipped to said key fob sized portable performance support device; and
a support center including a processor for determining the relevance and priority of the task, and assessing an event or condition to provide knowledge to the user through transmission to said key fob sized portable performance support device.

2. (canceled)

3. An apparatus comprising:
a key fob sized portable performance support device for allowing a user to be connected with all relevant information required for a task; and,
a miniaturized clip-on module adapted to be clipped onto said key fob sized portable performance support device, said miniaturized clip-on module including a sensor for sensing a predetermined parameter, a display and housing communications transceivers for communicating with a remote support center for transmitting information available at said key fob sized portable performance support device to said remote support center and for receiving instructions from said remote support center useful in guiding an individual to provide a support service, said miniaturized clip-on module being removably attachable to said key fob sized portable performance support device for providing a predetermined sensoring function, a predetermined communication function and a predetermined information display function such that the functionality of said key fob sized performance support device can be readily changed by changing the miniaturized clip-on module.

4. The apparatus of claim 3, wherein said sensoring function includes an environmental sensor.

5. The apparatus of claim 4, wherein said environmental sensor includes a gas sensor.

6. The apparatus of claim 3, wherein said sensoring includes an RFID tag reader.

7. The apparatus of claim 3, wherein said sensoring includes a man-down sensor.

8. The apparatus of claim 3, wherein said sensoring includes a proximity sensor.

9. The apparatus of claim 3, wherein said clip-on module includes optics for presenting images relating to a performance support function viewable at a wide angle.

10. The apparatus of claim 9, wherein said optics includes a miniaturized projector for projecting performance support information onto a surface remote from said device.

11. The apparatus of claim 9, wherein said optics includes an internal display and optical viewing eye piece for providing a wide angle view of said display, thus to permit viewing large amounts of information.

12. The apparatus of claim 3, wherein said sensoring includes audio sensoring.

13. The apparatus of claim 3, wherein said sensoring includes RF sensoring.

14. The apparatus of claim 3, wherein said miniaturized clip-on module includes a GPS receiver.

15. The apparatus of claim 3, wherein said miniaturized clip-on module includes a cellular modem.

16. The apparatus of claim 3, wherein said miniaturized clip-on module includes a satellite modem.

17. The apparatus of claim 3, wherein said miniaturized clip-on module includes a WiFi modem.

18. The apparatus of claim 3, wherein said miniaturized clip-on module includes a universal connector.

19. The apparatus of claim 18, wherein said universal connector includes one of a J-1708 connector, a J-1939 connector, a CAN bus connector, an RS-32 connector or a USB connector.

20. A key fob sized portable performance support device having flexible performance capabilities including a transceiver and a processor, said key fob sized portable performance support device adapted to accept a clip-on module that provides a predetermined functionality including predetermined sensors and a display for displaying large amounts of information such that the functionality of said key fob sized portable performance support device can be readily altered by the particular clip-on module clipped-on to said key fob sized portable performance support device.

21. The apparatus of claim 20, wherein said display includes one of an eye piece or projector to permit the display of large amounts of information.

22. The apparatus of claim 20, wherein said key fob sized portable performance support device includes at least one communications module to provide conductivity between said transceiver and a support server.

23. The apparatus of claim 20, wherein said clip-on module includes one of a cellular modem, a GPS receiver, a serial input, a discrete input, a processor for receiving remote firmware updates, an electronic key, a beacon, a transceiver for connecting to WiFi hot spots, an RFID reader, a scanner for a 2D matrix, a barcode reader and a user input device including one of a touch screen, a voice recognizer, a microphone, an USB interface, a universal connector for communicating, a video camera and a video conferencing application.

24. A portable performance support device and a clip-on module clipped thereto, the function of said portable performance support device being determined by said clip-on module, said clip-on module performing at least one of sensing, connecting, analyzing, predicting and performing of fault analysis, said portable performance support device operating within a point of performing operating architecture on and off a system, such that portable performance support device functionality is determined by the clip-on module that is clipped onto said portable performance support device, whereby said clip-on module provides ready adaptability to said portable performance support device.

25. The apparatus of claim 24, wherein said portable performance support device includes algorithms and applications that when synthesized provide information at the point of performance to permit support, the information being based on levels of synthesized information and available data.
